(19) United States
(12) Patent Application Publication
(10) Pub. No.: US 2025/0167446 A1
(43) Pub. Date: May 22, 2025

(54) ANTENNA FOR AN ELECTRONIC DEVICE

(71) Applicant: Hand Held Products, Inc., Charlotte, NC (US)

(72) Inventors: Kailash KASHYAP, Bengaluru (IN); Pankaj Kumar PANDEY, Bengaluru (IN); Abin CHIRIY ANKANDATH VARUKUTTY, Bengaluru (IN)

(21) Appl. No.: 18/941,718

(22) Filed: Nov. 8, 2024

(30) Foreign Application Priority Data
Nov. 22, 2023 (IN) 202311079339

(51) Int. Cl. H01Q 5/307; H01Q 1/22

(52) U.S. Cl. CPC H01Q 5/307; H01Q 1/2208

(57) ABSTRACT

An antenna is provided. The antenna includes, but not limited to, a ground element having a first shape, a radiating element having a second shape, and an enclosure having the second shape. The radiating element is electrically coupled with the ground element and the enclosure encloses the radiating element. The second shape of the enclosure and the radiating element is different from the first shape of the ground element.

### CROSS-REFERENCE TO RELATED APPLICATIONS

This application claims priority pursuant to 35 U.S.C. 119(a) to Indian Application No. 202311079339, filed Nov. 22, 2023, which application is incorporated herein by reference in its entirety.

### FIELD OF THE INVENTION

Exemplary embodiments of the present disclosure relate generally to electronic devices, and more particularly, to an antenna for the electronic devices.

### BACKGROUND

Antennas are widely used in electronic devices for the purpose of communicating data over a communication medium. Antennas are typically embedded in electronic devices and are configured to generate or receive signals over a communication network to interact with other devices.

However, the applicant has identified many technical challenges and difficulties associated with antennas for electronic devices. Through applied effort, ingenuity, and innovation, the Applicant has solved problems relating to antenna by developing solutions embodied in the present disclosure, which are described in detail below.

### BRIEF SUMMARY

Various embodiments described herein relate to components for antennas of communication systems.

In accordance with various embodiments of the present disclosure, an antenna is provided. The antenna includes, but not limited to, a ground element having a first shape and a radiating element having a second shape. The radiating element is electrically coupled to the ground element. The antenna further includes an enclosure having the second shape wherein the enclosure encloses the radiating element and wherein the second shape of the radiating element is different from the first shape of the ground element.

In some embodiments, the ground element comprises a first portion and a second portion.

In some embodiments, the first portion of the ground element is included within the enclosure and the second portion of the ground element is outside the enclosure.

In some embodiments, the antenna further comprises a housing wherein the housing encloses the antenna.

In some embodiments, the enclosure restricts the electromagnetic field distribution within the first portion of the ground element.

In some embodiments, the second shape of the enclosure includes at least one of a square, circle or an ellipse.

In some embodiments, one or more edges of the enclosure are parallel to one or more edges of the radiating element.

In some embodiments, an edge of the radiating element is positioned at a predetermined distance from an edge of the enclosure and is parallel to the edge of the enclosure.

In some embodiments an electronic device is provided. The device comprises of an antenna. The antenna includes, but not limited to, a ground element having a first shape and a radiating element having a second shape. The radiating element is electrically coupled to the ground element. The antenna further includes an enclosure having the second shape wherein the enclosure encloses the radiating element and wherein the second shape of the radiating element is different from the first shape of the ground element.

In some embodiments, an RFID (radio frequency identification device) device is provided. The RFID device comprises of an antenna. The antenna includes, but not limited to, a ground element having a first shape and a radiating element having a second shape. The radiating element is electrically coupled to the ground element. The antenna further includes an enclosure having the second shape wherein the enclosure encloses the radiating element and wherein the second shape of the radiating element is different from the first shape of the ground element.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates a side view of an electronic device, in accordance with various embodiments of the present disclosure;

FIG. 2 illustrates a perspective view of the antenna, in accordance with various embodiments of the present disclosure;

FIG. 3 illustrates a side view of an antenna, in accordance with various embodiments of the present disclosure;

FIG. 4 illustrates an exploded view of the antenna, in accordance with various embodiments of the present disclosure;

FIG. 5 illustrates a top view of the antenna, in accordance with various embodiments of the present disclosure;

FIG. 6 illustrates a current distribution on a surface of an example antenna, in accordance with various embodiments of the present disclosure;

FIG. 7 illustrates a radiation pattern generated by the antenna, in accordance with various embodiments of the present disclosure;

FIG. 8 illustrates example curves illustrating the performance parameters of the antenna, namely the return loss, the circular polarization gain and the axial ratio vs frequency of the antenna, in accordance with various embodiments of the present disclosure;

FIG. 9A illustrates an alternate structure of the antenna, in accordance with various embodiments of the present disclosure;

FIG. 9B illustrates another alternate structure of the antenna, in accordance with various embodiments of the present disclosure;

FIG. 10 illustrates a block diagram of an example RFID communication system, in accordance with various embodiments of the present disclosure; and,

FIG. 11 illustrates a block diagram of an example controller of the example RFID communication system, in accordance with various embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as “comprises”, “includes”, and “having” should be understood to provide support for narrower terms such as “consisting of”, “consisting essentially of”, and “comprised substantially of”.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Antennas are widely used in electronic devices such as, but not limited to, a Radio Frequency Identification (RFID) reader for the purpose of communicating data over a wireless medium. Some examples of such antennas include, but not limited to, patch antennas, turnstile antennas, corner reflector antennas and/or the like. Often antennas used in such electronic devices are configured to generate signal having predetermined polarization, e.g., circular polarization. However, performance metrics of such polarized signal is dependent on a shape of the electronic device, itself, in which the antenna is embedded. More specifically, the performance metrics of the circularly polarized signal is dependent on the shape of a ground element of the antenna, which may govern the shape of the electronic device.

In accordance with various embodiments of the present disclosure, an antenna is provided. The antenna includes, but not limited to, a ground element having a first shape, and a radiating element having a second shape. In some examples, the radiating element may be electrically coupled to the ground element. The antenna further includes an enclosure having the second shape and is positioned to enclose the radiating element. The second shape of the radiating element is different from the first shape of the ground element. In some embodiments, a first portion of the ground element is included within the enclosure and a second portion of the ground element is outside the enclosure. In some embodiments, the enclosure restricts the electromagnetic field distribution within the first portion of the ground element. In some embodiments, the second shape of the enclosure includes at least one of a square, circle or an ellipse. In some embodiments, one or more edges of the enclosure are parallel to one or more edges of the radiating element. In some embodiments, an edge of the radiating element is positioned at a predetermined distance from an edge of the enclosure and is parallel to the edge of the enclosure.

The advantage of the example antenna is, in some examples, enhanced performance metrics of the antenna that is achieved by the enclosure, such that the antenna can be easily embedded into the other electronic devices, irrespective of the shape of the electronic device.

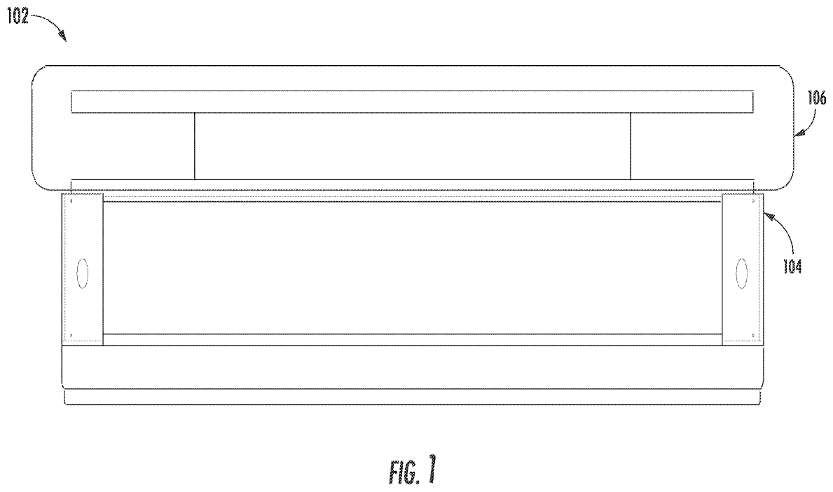

FIG. 1 illustrates a side view 100 of an electronic device 102, in accordance with various embodiments of the present disclosure. In an example embodiment, the electronic device 102 includes a housing 104 and an antenna 106.

In an example embodiment, the electronic device 102 may correspond to a device that is capable of transmitting and receiving messages and/or data over a communication network such as, but not limited to, a wireless communication network and/or wired communication network such as, but not limited to, communication over radio frequency, Near Field Communication (NFC), I2C (Inter integrated circuit), TCP/IP (Transmission control protocol/Internet protocol), UDP (User datagram protocol), or 2G, 3G, 4G or 5G communication protocols or cellular networks, wireless local area networks (WLAN), satellite communication networks or microwave networks, etc. For example, the electronic device 102 may be configured to communicate with one or more RFID tags. To this end, the electronic device 102 may utilize the antenna 106 for transmitting an interrogation signal to the one or more RFID tags. In response to the interrogation signal, the electronic device 102 may receive a response from the one or more RFID tags through the antenna 106. Some examples of the electronic device 102 includes, but are not limited to, RFID readers or transceivers, hand-held scanners, cell phones, etc.

In an example embodiment, the housing 104 may correspond to a recessed cover which is configured to house the antenna 106 of the electronic device. For example, the housing 104 may be made of a non-conducting material such as a polymer. In some examples, the housing 104 may be configured to prevent entry of foreign particles, such as, dust or water into the electronic device.

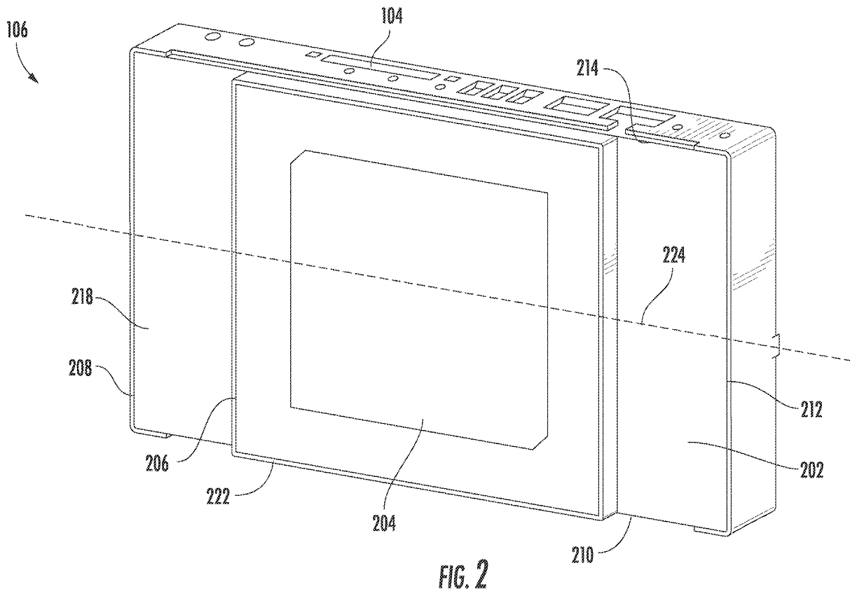

In an example embodiment, the antenna 106 may be configured to generate or receive signals over a communication network, such as, but not limited to, a wireless communication network and/or wired communication network such as but not limited to communication over radio frequency, Near Field Communication (NFC), cellular networks, wireless local area networks (WLAN), satellite communication networks or microwave networks, etc. In an example embodiment, the antenna 106 may be configured to generate signal having predetermined polarization, such as, circular polarization. In an example embodiment, the structure of the antenna 106 is further described in conjunction with FIGS. 2, 3, and 4.

FIG. 2 illustrates a perspective of the antenna 106, in accordance with the one or more embodiments of the present disclosure. In an example embodiment, the antenna 106 comprises a ground element 202, a radiating element 204 and an enclosure 206.

In an example embodiment, the ground element 202 corresponds to a flat conducting surface that may reflect waves received from other antennas. In some examples, the reflected waves are detected by the radiating element 204. For instance, the signals from one or more RFID tags are reflected by the ground element 202 towards the radiating element 204. In another example, the signal generated by the radiating element 204 are reflected by the ground element 202 towards the other antennas (such as the one or more RFID tags). In an example embodiment, a size of the ground element 202 is λ/4 of the wavelength of the signal transmitted/received by the radiating element 204. In one example, the ground element 202 is electrically coupled with the radiating element 204. In another example, the ground element 202 is electrically decoupled and/or disconnected from the radiating element 204. In an example embodiment, the ground element 202 has a first shape. Some examples of the first shape may include, but not limited to, a rectangular shape, a circular shape, and a square shape. The ground element may include any other shape without departing from the scope of the invention. For the purpose of ongoing description, the shape of the ground element 202 is considered to be rectangular shape, however, those having ordinary skills in the art would appreciate that scope of the disclosure is not limited to the ground element 202 having a rectangular shape. In an example embodiment, the ground element 202 has a first edge 208, a second edge 210, a third edge 212, and a fourth edge 214. In some examples, the first edge 208 and the third edge 212 are indicative of a width of the ground element 202, while the second edge 210 and the fourth edge 214 are indicative of the length of the ground element 202. In an example embodiment, the ground element 202 comprises a first portion 216 and a second portion 218. The first portion 216 extends between the first edge 208, the second edge 210, the third edge 212, the fourth edge 214, and a boundary 220 between the first portion 216 and the second portion 218. To this end, the second portion 218 and the ground element 202 may correspond to concentric polygons. In some examples, the scope of the disclosure is not limited to the second portion 218 of the ground element 202 and the ground element 202, itself, corresponding to the concentric polygons. In one example embodiment, the second portion 218 of the ground element 202 may be defined at an offset from a center of the ground element 202. For instance, the second portion 218 of the ground element 202 may be defined to be close of at least one of the first edge 208, the second edge 210, the third edge 212, and/or the fourth edge 214. Some examples of the ground element 202 includes, but not limited to, ground plane, substrate, or a printed circuit board.

In an example embodiment, the second portion 218 of the ground element 202 is configured to receive the enclosure 206. In some examples, an edge 222 of the enclosure 206 coincides with the boundary 220 between the first portion 216 of the ground element 202 and the second portion 218 of the ground element 202. The enclosure 206 may correspond to a frame having a predetermined width along a first axis 224 of the electronic device 202. For instance, the width of the enclosure may range between 19 mm and 20 mm. In an example embodiment, the enclosure 206 may be composed of metal such as copper, aluminum, and/or any other conductive material. In some examples, the scope of the disclosure is not limited to disposing the enclosure 206 on the second portion 218 of the ground element 202. In an example embodiment, the enclosure 206 may be fabricated directly on the ground element 202, without departing from the scope of the disclosure. To this end, the ground element 202 may correspond to a PCB on which the enclosure 206 is fabricated.

In an example embodiment, the enclosure 206 may have a second shape that is different from the first shape of the ground element 202. For example, the second shape of the enclosure 206 may correspond to a square shape, however, the scope of the disclosure is not limited to the enclosure 206 having the square shape. In some examples, the enclosure 206 may have a circular shape, an elliptical shape, and/or any other shape.

In an example embodiment, the radiating element 204 is disposed within the enclosure 206 (which is disposed in the second portion 218 of the ground element 202). The radiating element is often configured to generate the electromagnetic (EM) wave that is transmitted to the other devices. In some embodiments, the radiating element 204 may be configured to receive EM waves from other electronic device such as RFID tag. Additionally, or alternatively, the radiating element 204 may be configured to transmit an electromagnetic signal to an RFID passive tag antenna to excite the RFID passive tag antenna. In some examples, tag integrated circuit (IC) information may be transmitted by the RFID passive tag antenna back to the radiating element 204. In some examples, the electromagnetic waves radiated from the radiating element 204 may be circularly polarized. In some examples, the radiating element 204 may correspond to an etched metal layer (not shown) on the PCB that may have the second shape to allow transmission and reception of the EM waves. For example, the radiating element 204 may have a loop structure in a square shape. However, the scope of the disclosure is not limited to the radiating element having a square shape. In an example embodiment, the radiating element 204 may have any other shape that allows transmission and reception of the EM waves. In an example embodiment, the shape of the radiating element 204 is same as the shape of the enclosure 206. Some examples of radiating element include patch antennas which may be square, rectangular, circular, or elliptical in shape.

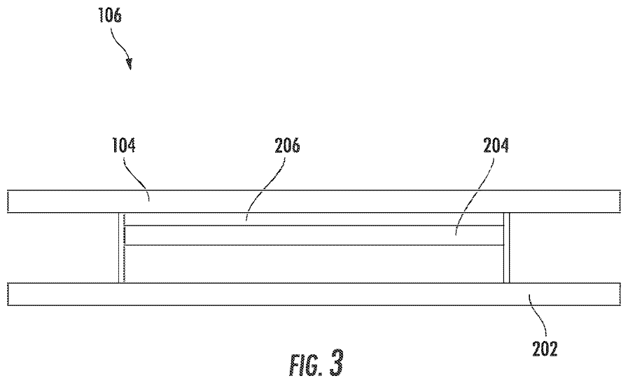

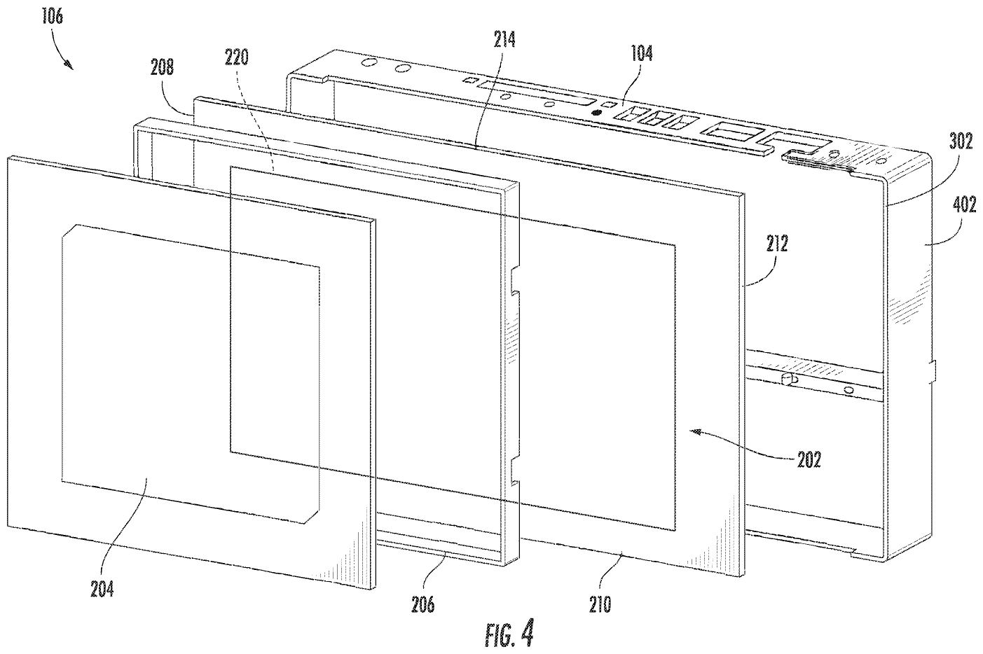

Referring to FIG. 3 and FIG. 4A, a side view 300 and an exploded view 400 of the antenna 106 are illustrated, in accordance with one or more embodiments of the present disclosure.

In some examples, the side view 300 illustrates the ground element 202, the enclosure 206, and the radiating element 204. In an example embodiment, the enclosure 206 is disposed on the ground element 202. Further, the radiating element 204 is received in the enclosure 206 and is disposed on the ground element 202. Further, a front portion 302 of the housing 104 is disposed on the enclosure 206. In some examples, the shape of the portion of the housing 104 is same as the first shape of the ground element 202. In an alternate embodiment, the radiating element 204 may be separate from the ground element 202 may not be disposed on the ground element 202. To this end, the radiating element 204 may be electrically coupled to the ground element 202 and may be within the enclosure 206.

Referring to the exploded view 400, the ground element 202 is received within a rear portion 402 of the housing 104. Further, referring to the exploded view 400, the enclosure 206 is received within the second portion 218 of the ground element 202. The perimeter/periphery of the enclosure 206 coincides with the boundary 220 between the first portion 216 of the ground element 202 and the second portion 218 of the ground element 202. Further, the radiating element 204 is disposed between the enclosure 206.

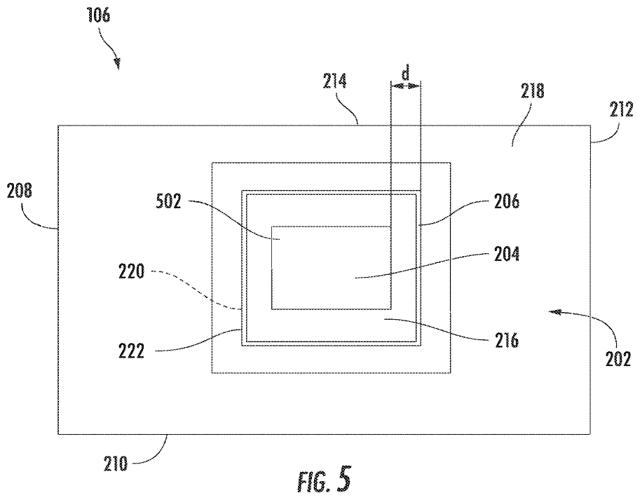

Referring to FIG. 5, a top view 500 of the antenna 106 is illustrated, according to one or more embodiments of the present disclosure. In an example embodiment, an edge 502 of the radiating element 204 is positioned at a predetermined distance from of the enclosure 206. In an example embodiment, the predetermined distance d is determined based on following mathematical relation (Eq. 1):

$$d \geq 0.6 λ \qquad Eq . 1$$

where, λ: Wavelength of the signal transmitted by the radiating element 204.

For example, the predetermined distance d may range between 19 mm and 20 mm.

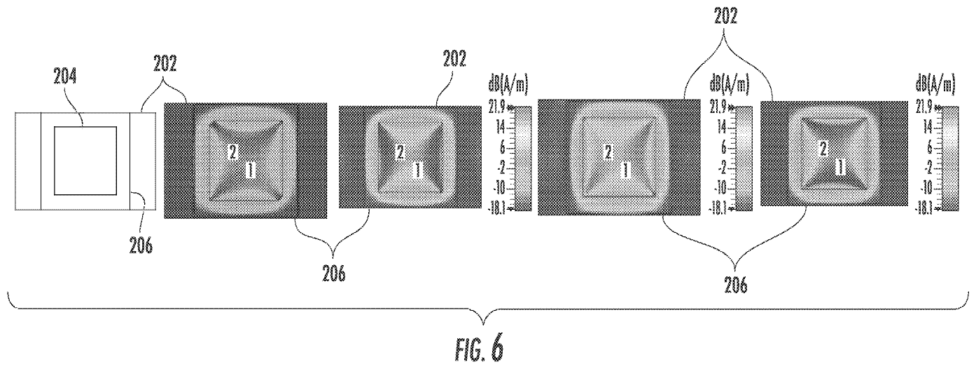

In some examples, the enclosure 206 restricts the current distribution only within the second portion 218 of the ground element 202. Referring now to FIG. 6, an example diagram illustrating a current distribution on a surface of an example antenna 106 in accordance with some example embodiments described herein is provided.

In some embodiments, an EM field generated by the example antenna 106 may be a combination of an electric field and a magnetic field. For example, the electric field may be directly proportional to a current on the surface of the example antenna 106. For example, the electric field E may be calculated with following equation (Eq. 2).

$$E = J / σ \qquad Eq . 2$$

where J is a current density on the surface of the antenna 106, and σ is a conductivity of the material of the antenna.

For example, the magnetic field may be directly proportional to a voltage on the surface of the example antenna 106. For example, the magnetic field B may be calculated with following equation (Eq. 3).

$$B = V / L \qquad Eq . 3$$

where V is the voltage on the surface of the antenna, and L is an inductance of the material of the antenna.

In some embodiments, the current on the surface of the example antenna 106 may be visualized when the current on the surface of the example antenna 106 is fed with different phases. For example, the current on the surface of the example antenna 106 may change alone when a phase of a feed to the example antenna 106 is changing between 0°, 90°, 180°, and 270°.

For example, a direction of the current may be in a horizontal direction 601 when on the feed to the example antenna 106 has a phase at 0°. For example, a direction of the current may be in a vertical direction 602 when on the feed to the example antenna 106 has a phase at 90°. For example, a direction of the current may be in a horizontal direction 603 when on the feed to the example antenna 106 has a phase at 180°. For example, a direction of the current may be in a vertical direction 604 when on the feed to the example antenna 106 has a phase at 270°.

For example, a circular polarization may be achieved when the phase of the antenna is switched from 0° to 90°, 90° to 180°, 180° to 270° in the example antenna 106. In some embodiments, when the example antenna 106 may be operating in a circular polarization, the current on the surface of the example antenna 106 may be flow in a circular form. For example, at 0 degrees phase, the current flow is X direction when the current on the surface of the example antenna 106 is varying the phase from 0° to 90°, to 180°, and further to 270°.

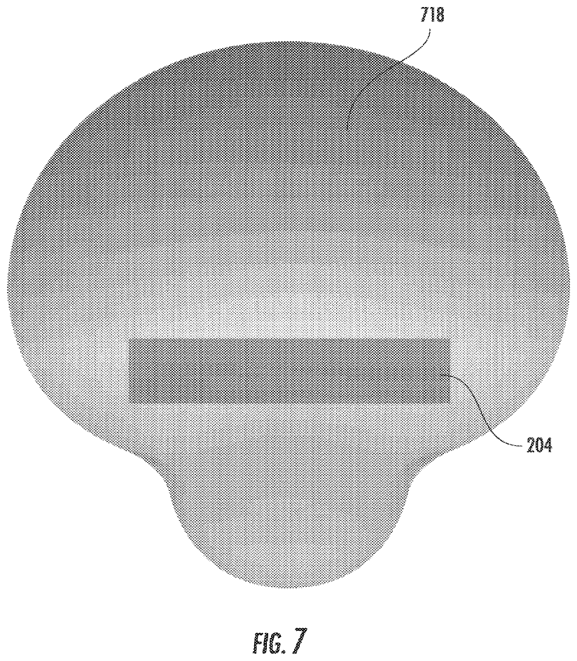

FIG. 7 illustrates a radiation pattern generated by the antenna, in accordance with various embodiments of the present disclosure. In some examples, the radiation of electro-magnetic waves from the radiating element 204 may have a directional radiation pattern. For example, radiation energy, of the electro-magnetic waves, may be concentrated in a main lobe 718 of the directional radiation pattern.

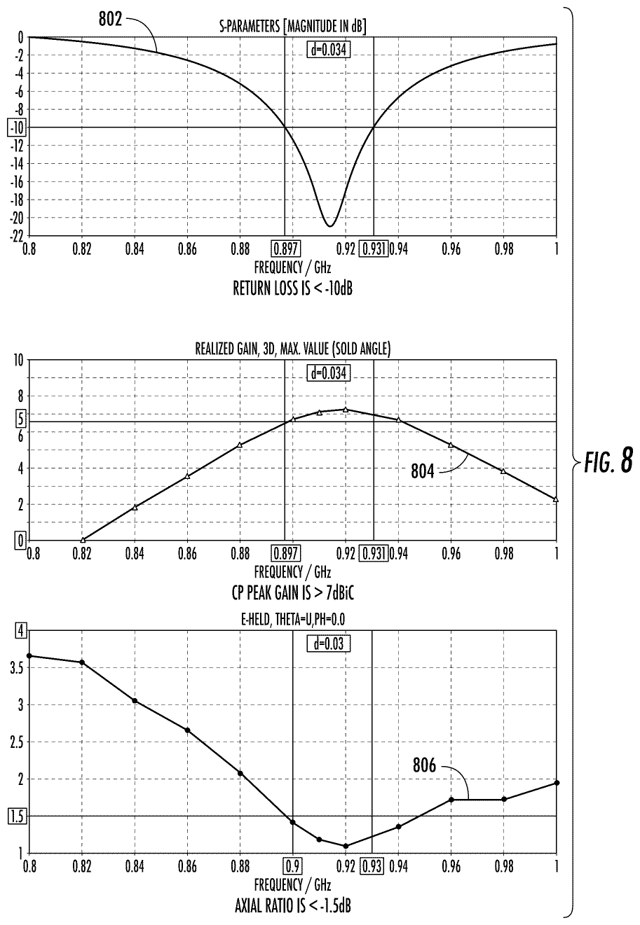

Referring now to FIG. 8, example curves (802, 804, 806) illustrating a return loss, circular polarization (CP) gain, and an axial ratio vs frequency of an example antenna 106 in accordance with some example embodiments described herein are provided.

As shown on the curve 802 of FIG. 8, in some examples, a peak return loss of the example antenna 106 may be less than −10 dB when the frequency of the electro-magnetic signal is varying in a range between 890 MHz to 940 MHz. In some embodiments, the frequency band of the antenna 106 may be based on the frequency range where the peak return loss of the example antenna is less than −10 dB. For example, the frequency band of the example antenna may be 915 MHz.

As shown on the curve 804 of FIG. 8, in some examples, the peak CP gain of the example antenna 106 may be more than 6.5 dBiC when the frequency of the electro-magnetic signal is around 1110 MHz.

As shown on the curve 806 of FIG. 8, in some examples, the axial ratio of the example antenna 106 may be less than −1.5 dB when the frequency of the electro-magnetic signal is around 915 MHz. In some examples, the axial ratio of the antenna is <1.5 over the operating frequency band of the antenna 106.

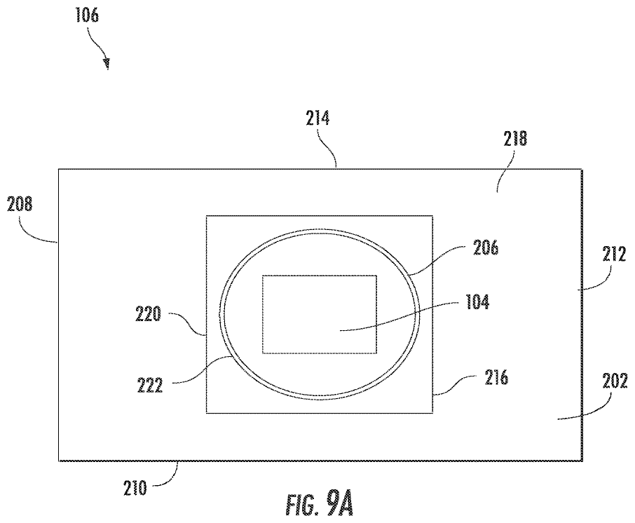

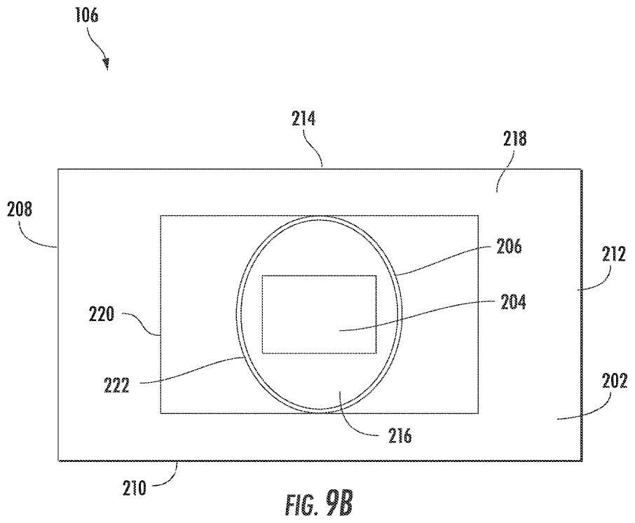

Referring now to FIG. 9A, and FIG. 9B, an example diagram illustrating an example antenna, in accordance with various embodiments of the present disclosure is provided. In some examples, the second shape of the enclosure 206 may be a circle or an ellipse.

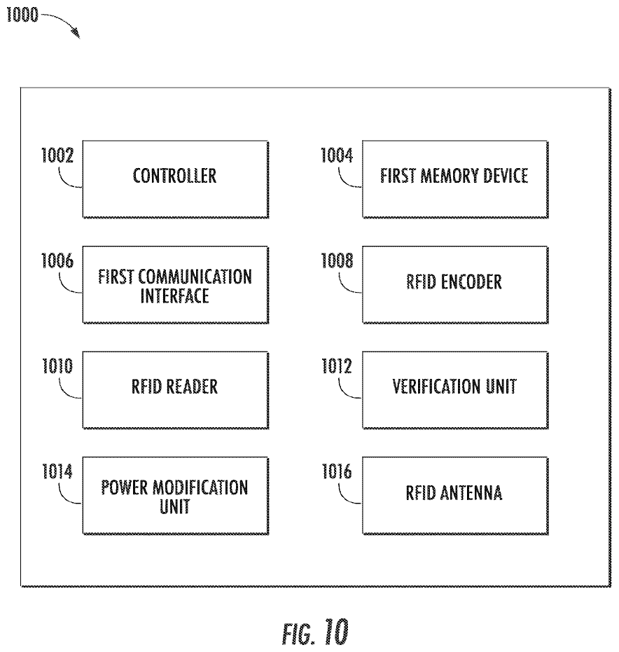

FIG. 10 illustrates a block diagram of an example RFID communication system, according to one or more embodiments described herein. For example, the example RFID communication system 1000 may include a controller 1002, a first memory device 1004, a first communication interface 1006, an RFID encoder 1008, an RFID reader 1010, a verification unit 1012, a power modification unit 1014, and an antenna 1016. In some examples, the antenna 1016 of the example RFID communication system 1000 described herein may correspond to the antenna 106 as described in, FIG. 2, FIG. 3, FIG. 4, FIG. 5, FIG. 6, FIG. 7A, FIG. 7B, FIG. 8 and FIG. 9.

The controller 1002 may be embodied as means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof. Accordingly, although illustrated in FIG. 9 as a single controller, in an embodiment, the controller 1002 may include a plurality of controllers and signal processing modules. The plurality of controllers may be embodied on a single electronic device or may be distributed across a plurality of electronic devices collectively configured to function as the circuitry of the example RFID communication system 1000. The plurality of controllers may be in operative communication with each other and may be collectively configured to perform one or more functionalities of the circuitry of the example RFID communication system 1000, as described herein. In an example embodiment, the controller 1002 may be configured to execute instructions stored in the first memory device 1004 or otherwise accessible to the controller 1002. These instructions, when executed by the controller 1002, may cause the circuitry of the example RFID communication system 1000 to perform one or more of the functionalities, as described herein.

Whether configured by hardware, firmware/software methods, or by a combination thereof, the controller 1002 may include an entity capable of performing operations according to embodiments of the present disclosure while configured accordingly. Thus, for example, when the controller 1002 is embodied as an ASIC, FPGA or the like, the controller 1002 may include specifically configured hardware for conducting one or more operations described herein. Alternatively, as another example, when the controller 1002 is embodied as an executor of instructions, such as may be stored in the first memory device 1004, the instructions may specifically configure the controller 1002 to perform one or more algorithms and operations described herein.

Thus, the controller 1002 used herein may refer to a programmable microprocessor, microcomputer or multiple processor chip or chips that can be configured by software instructions (applications) to perform a variety of functions, including the functions of the various embodiments described above. In some devices, multiple processors may be provided dedicated to wireless communication functions and one processor dedicated to running other applications. Software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. The memory can also be located internal to another computing resource (e.g., enabling computer readable instructions to be downloaded over the Internet or another wired or wireless connection).

The first memory device 1004 may include suitable logic, circuitry, and/or interfaces that are adapted to store a set of instructions that is executable by the controller 1002 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an embodiment, the first memory device 1004 may be integrated with the controller 1002 on a single chip, without departing from the scope of the disclosure.

The first communication interface 1006 may correspond to a communication interface that may facilitate transmission and reception of messages and data to and from various components of the example RFID communication system 1000. Examples of the communication interface may include, but are not limited to, an antenna, an Ethernet port, a USB port, a serial port, or any other port that can be adapted to receive and transmit data. The communication interface transmits and receives data and/or messages in accordance with the various communication protocols, such as, I2C, TCP/IP, UDP, and 2G, 3G, 4G or 5G communication protocols.

The RFID encoder 1008 includes suitable logic, and circuitry for encoding the electro-magnetic signal data. In some example embodiments, the RFID encoder 1008 encodes the electro-magnetic signal data, according to one or more of Electronic Product code (EPC) or Department of Defense (DOD) formats. In some examples, the RFID encoder 1008 may be configured to transmit the data over one or more frequency bands such as, but not limited to, 13.56 MHz (hereinafter “High Frequency band” or “HF”) or 860 MHz-960 MHZ (hereinafter “UHF band”), through the antenna 1016. Further, the RFID encoder 1008 may be configured to modulate the data on an RF carrier of either HF frequency band or UHF band prior to transmitting the data. Some examples of the modulation techniques utilized by the RFID encoder 1008 include, but are not limited to, Phase Jitter Modulation (PJM), Amplitude Shift Keying (ASK), and/or the like.

In some examples, the RFID encoder 1008 may be configured to transmit one or more commands to an RFID passive tag antenna, causing the RFID passive tag antenna to perform a predetermined operation in accordance with the one or more commands. For example, the RFID encoder 1008 may transmit a command “Write” that indicates to the RFID passive tag antenna to write the data accompanied with the command in the memory of the RFID passive tag antenna. Similarly, the RFID encoder 1008 may transmit other commands to the RFID passive tag antenna such as but not limited to “Lock”, “Access”, “Block Write”, and/or any other command according to the EPC global standards.

The RFID reader 1010 includes suitable logic and circuitry for reading data from the RFID passive tag antenna. To read the data encoded in the RFID passive tag antenna, the RFID reader 1010 may transmit an interrogation command to the RFID inlay over the one or more frequency bands such as HF and UHF. Further, like the RFID encoder 1008, the RFID reader 1010 may also utilize the one or more modulation techniques such as ASK and PJM to transmit the interrogation command on the one or more frequency bands. In response to the interrogation command, the RFID reader 1010 may receive the encoded data from the RFID passive tag antenna. In an example embodiment, the RFID reader 1010 may utilize the antenna 1016 to transmit the interrogation command and receive the encoded data from the RFID passive tag antenna.

In some examples, both the RFID reader 1010 and the RFID encoder 1008 may include one or more of filters, analog to digital (A/D) converters, Digital to Analog (D/A) convertors, matching circuits, amplifiers, and/or tuners that enable the RFID reader 1010 and the RFID encoder 1008 to transmit and receive data over the one or more frequency bands through the antenna 1016.

The verification unit 1012 includes suitable logic and circuitry that is configured to verify whether the encoding of the RFID passive tag antenna is successful. In some examples, to determine whether the encoding is successful, the verification unit 1012 may determine an encode success rate. The verification unit 1012 may be implemented using one or more hardware components, such as, but not limited to, FPGA, ASIC, and the like.

The power modification unit 1014 includes suitable logic and circuitry that is configured to manage a signal transmission power of the antenna 1016. In an example embodiment, the signal transmission power corresponds to a transmitter power output at which a signal is transmitted from the antenna 1016. In an example embodiment, the power modification unit 1014 may be configured to modify the signal transmission power in accordance with a plurality of power settings. In an example embodiment, a power setting may correspond to a value of the signal transmission power with which the data is transmitted from the antenna 1016. In some examples, the power modification unit 1014 may modify input voltage to the antenna 1016 to modify the signal transmission power. In an example embodiment, the power modification unit 1014 may modify the signal transmission power in response to an instruction received from the controller 1002. The power modification unit 1014 may be implemented using one or more hardware components, such as, but not limited to, FPGA, ASIC, and the like.

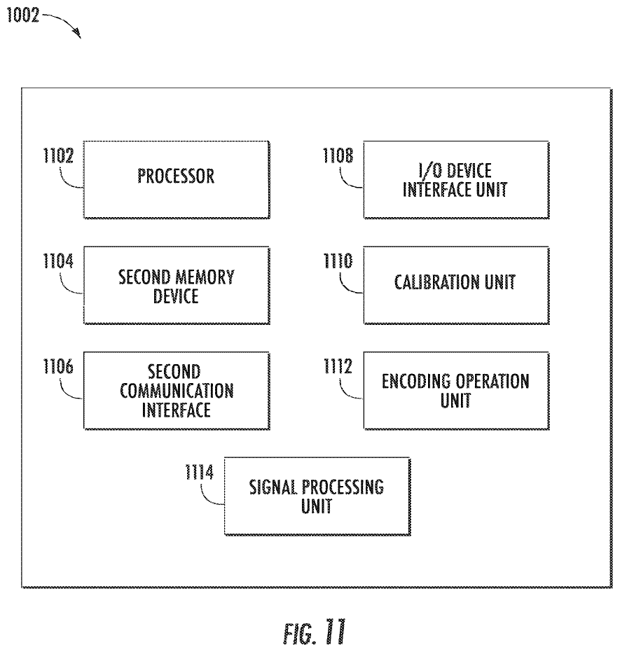

FIG. 11 illustrates a block diagram of the controller 1002 of the example RFID communication system 1000, according to one or more embodiments described herein. The controller 1002 includes a processor 1102, a second memory device 1104, a second communication interface 1106, an input/output (I/O) device interface unit 1108, a calibration unit 1110, an encoding operation unit 1112, and a signal processing unit 1114.

The processor 1102 may be embodied as means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof. Accordingly, although illustrated in FIG. 9 as a single processor, in an embodiment, the processor 1102 may include a plurality of processors and signal processing modules. The plurality of processors may be embodied on a single electronic device or may be distributed across a plurality of electronic devices collectively configured to function as the circuitry of the controller 1002. The plurality of processors may be in operative communication with each other and may be collectively configured to perform one or more functionalities of the circuitry of the controller 1002, as described herein. In an example embodiment, the processor 1102 may be configured to execute instructions stored in the second memory device 1104 or otherwise accessible to the processor 1102. These instructions, when executed by the processor 1102, may cause the circuitry of the controller 1002 to perform one or more of the functionalities, as described herein.

Whether configured by hardware, firmware/software methods, or by a combination thereof, the processor 1102 may include an entity capable of performing operations according to embodiments of the present disclosure while configured accordingly. Thus, for example, when the processor 1102 is embodied as an ASIC, FPGA or the like, the processor 1102 may include specifically configured hardware for conducting one or more operations described herein. Alternatively, as another example, when the processor 1102 is embodied as an executor of instructions, such as may be stored in the second memory device 1104, the instructions may specifically configure the processor 1102 to perform one or more algorithms and operations described herein.

Thus, the processor 1102 used herein may refer to a programmable microprocessor, microcomputer or multiple processor chip or chips that can be configured by software instructions (applications) to perform a variety of functions, including the functions of the various embodiments described above. In some devices, multiple processors may be provided dedicated to wireless communication functions and one processor dedicated to running other applications. Software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. The memory can also be located internal to another computing resource (e.g., enabling computer readable instructions to be downloaded over the Internet or another wired or wireless connection).

The second memory device 1104 may include suitable logic, circuitry, and/or interfaces that are adapted to store a set of instructions that is executable by the processor 1102 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an example embodiment, the second memory device 1104 may be integrated with the processor 1102 on a single chip, without departing from the scope of the disclosure.

The second communication interface 1106 may correspond to a second communication interface 1106 that may facilitate transmission and reception of messages and data to and from various devices. For example, the second communication interface 1106 is communicatively coupled with a computing device (not shown). For example, through the second communication interface 1106, the example RFID communication system 1000 may be configured to receive commands/jobs from the computing device based on which the example RFID communication system 1000 may perform predetermined operation. Examples of the second communication interface 1106 may include, but are not limited to, an antenna, an Ethernet port, a USB port, a serial port, or any other port that can be adapted to receive and transmit data. The second communication interface 1106 transmits and receives data and/or messages in accordance with the various communication protocols, such as, I2C, TCP/IP, UDP, and 2G, 3G, 4G or 5G communication protocols.

The I/O device interface unit 1108 may include suitable logic and/or circuitry that may be configured to communicate with the one or more components of the example RFID communication system 1000, in accordance with one or more device communication protocols such as, but not limited to, I2C communication protocol, Serial Peripheral Interface (SPI) communication protocol, Serial communication protocol, Control Area Network (CAN) communication protocol, and 1-Wire® communication protocol. In an example embodiment, the I/O device interface unit 1108 may communicate with other components of the example RFID communication system 1000. Some examples of the I/O device interface unit 1108 may include, but not limited to, a Data Acquisition (DAQ) card, an electrical drives driver circuit, and/or the like.

The calibration unit 1110 may include suitable logic and/or circuitry for calibrating the example RFID communication system 1000. In an example embodiment, the calibration unit 1110 may be configured to determine one or more properties of the example antenna 106. The calibration unit 1110 may be implemented using one or more hardware components, such as, but not limited to, FPGA, ASIC, and the like.

The encoding operation unit 1112 may include suitable logic and/or circuitry for operating the example RFID communication system 1000 in the encoding mode. In an example embodiment, the encoding operation unit 1112 may be configured to cause the RFID encoder 1008 in the example RFID communication system 1000 to encode the RFID passive tag antenna, through the antenna 1016. The encoding operation unit 1112 may be implemented using one or more hardware components, such as, but not limited to, FPGA, ASIC, and the like.

The signal processing unit 1114 may include suitable logic and/or circuitry for analyzing the input signal received from a media sensor. For example, the signal processing unit 1114 may include a digital signal processor (e.g., 1102) that may be configured to identify the peaks and the valleys in the input signal. Further, the signal processing unit 1114 may utilize one or more signal processing techniques such as, but not limited to, Fast Fourier Transform (FFT), Discrete Fourier Transform (DFT), Discrete Time Fourier Transform (DTFT) to analyze the input signal. The signal processing unit 1114 may be implemented using one or more hardware components, such as, but not limited to, FPGA, ASIC, and the like.

In some examples the scope of the disclosure is not limited to having a separate controller 1002 for the example RFID communication system 1000. In an alternative embodiment, various units/modules of the controller 1002 may be implemented on example RFID communication system 1000, forming an integrated, single apparatus, without departing from the scope of the disclosure. In another alternative embodiment, various functionalities of the example RFID communication system 1000 may be implemented in the controller 1002, forming an integrated, single apparatus, without departing from the scope of the disclosure. In such an implementation, the antenna 1016 may be directly communicatively coupled to the controller 1002.

As described above and as will be appreciated based on this disclosure, embodiments of the present disclosure may include various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. An antenna comprising:
a ground element having a first shape;
a radiating element having a second shape, wherein the radiating element is electrically coupled with the ground element; and,
an enclosure having the second shape, wherein the enclosure encloses the radiating element, and wherein the second shape of the enclosure and the radiating element is different from the first shape of the ground element.

2. The antenna according to claim 1, wherein the ground element comprises a first portion and a second portion.

3. The antenna according to claim 2, wherein the second portion of the ground element is included within the enclosure, and the first portion of the ground element is outside the enclosure.

4. An antenna according to claim 3, wherein the enclosure restricts the current distribution within the second portion of the ground element.

5. The antenna according to claim 1, wherein the second shape of the enclosure includes at least one of a square, a circle, or an ellipse.

6. The antenna according to claim 1, wherein one or more edges of the enclosure are parallel to one or more edges of the radiating element.

7. The antenna element of claim 1, wherein an edge of the radiating element is positioned at a predetermined distance from an edge of the enclosure and is parallel to the edge of the enclosure.

8. An electronic device comprising of an antenna, the antenna comprising:
a ground element having a first shape;
a radiating element having a second shape, wherein the radiating element is electrically coupled with the ground element; and,
an enclosure having the second shape, wherein the enclosure encloses the radiating element, and wherein the second shape of the enclosure and the radiating element is different from the first shape of the ground element.

9. The electronic device according to claim 8, wherein the ground element comprises a first portion and a second portion.

10. The electronic device according to claim 9, wherein the second portion of the ground element is included within the enclosure, and the first portion of the ground element is outside the enclosure.

11. The electronic device according to claim 10, wherein the enclosure restricts the current distribution within the second portion of the ground element.

12. The electronic device according to claim 8, wherein the second shape of the enclosure includes at least one of a square, a circle, or an ellipse.

13. The electronic device according to claim 8, wherein one or more edges of the enclosure are parallel to one or more edges of the radiating element.

14. The electronic device according to claim 8, wherein an edge of the radiating element is positioned at a predetermined distance from an edge of the enclosure and is parallel to the edge of the enclosure.

15. A radio frequency identification device (RFID) comprising an antenna, the antenna comprising:
a ground element having a first shape;
a radiating element having a second shape, wherein the radiating element is electrically coupled with the ground element; and,
an enclosure having the second shape, wherein the enclosure encloses the radiating element, and wherein the second shape of the enclosure and the radiating element is different from the first shape of the ground element.

16. The RFID device according to claim 15, wherein the ground element comprises a first portion and a second portion.

17. The RFID device according to claim 16, wherein the second portion of the ground element is included within the enclosure, and the first portion of the ground element is outside the enclosure.

18. The RFID device according to claim 17, wherein the enclosure restricts the current distribution within the second portion of the ground element.

19. The RFID device according to claim 15, wherein the second shape of the enclosure includes at least one of a square, a circle, or an ellipse.

20. The RFID device according to claim 15, wherein one or more edges of the enclosure are parallel to one or more edges of the radiating element.
